(19) United States
(12) Patent Application Publication
(10) Pub. No.: US 2015/0324342 A1
(43) Pub. Date: Nov. 12, 2015

(54) METHOD AND APPARATUS FOR ENRICHING SOCIAL MEDIA TO IMPROVE PERSONALIZED USER EXPERIENCE

(71) Applicant: NOKIA TECHNOLOGIES OY, Espoo (FI)

(72) Inventors: Alvin Chin, Beijing (CN); Jilei Tian, Beijing (CN)

(73) Assignee: NOKIA TECHNOLOGIES OY, Espoo (FI)

(21) Appl. No.: 14/655,100

(22) PCT Filed: Jan. 11, 2013
(86) PCT No.: PCT/CN2013/070343

§ 371 Date: Jun. 24, 2015

(51) Int. Cl. G06F 17/24; G06F 17/30

(52) U.S. Cl. CPC G06F 17/241; G06F 17/30525

(57) ABSTRACT

A method and apparatus for enriching social media to improve personalized user experience are provide, the method comprising: receiving highlights and/or annotations in at least one electronic document made by at least one user; extracting keywords from the respective at least one electronic document with the highlights and/or annotations as tags of the respective at least one electronic document; and using the keywords as tags of the respective at least one electronic document to provide personalized contents from the at least one electronic document to a user. Thus, by having high quality/relevant tags from a plurality of users for a given document, we may better profile the document. Similarly, by having high quality and insightful tags that a user has given to a plurality of documents, we may better profile the user's interest and behavior. By having better document and user profiling, we may better recommend the right documents to right users. In addition, we may offer more interesting UI features to improve user experience and engagement.

### TECHNICAL FIELD

The present invention relates to social media and recommendation, and particularly to utilizing highlights and/or annotations made by users to enrich social media to improve personalized user experience.

### BACKGROUND

Traditionally, authors write down articles and have them published in paper-printed media, such as newspapers, magazines, and books. Users can read the articles and make annotations and highlights therein to emphasize what is important or valuable to them and express their opinions on points of interest to them. From these annotations and highlights, we can not only grasp important points of the article without having to read the entire article, but also know the users who made these annotations and highlights to some extent. However, these annotations and highlights in the traditional media are mostly for personal use without social impact.

With the advent and evolution of the Internet, authors can publish articles in internet social media channels, such as portals, BBS, e-books, and blogs. Often, users can mark their personal emotions/opinions on the article, such as likes, shares and ratings. Thus, the internet social media provide more user participation and interaction with authors and with each other than the traditional paper-printed media. However, current technologies on internet social media are still limited in the following aspects:

1. Users' comments are usually separated from the original article, not annotated within the article, and are processed separately from the article, in terms of user interaction, interface, data analysis, and recommendation. Users cannot take any authorship role, and are not highly motivated and engaged in reading and co-authorship of the article.

2. Users' annotations and highlights in an article are not fully utilized to provide richer and configurable views of the article incorporating the social wisdom of the users.

3. Users' annotations and highlights in different articles are not fully utilized to generate data of high quality and large amount on the users so as to profile the users for various purposes, such as recommendation.

4. Current recommendation of content is based on performing a content analysis of the entire article to extract keywords, but often, it is only a few paragraphs or sentences that are important, not the entire article; and current recommendation does not utilize users' annotations in the article.

### BRIEF SUMMARY

To overcome one or more of the above limitations or other limitations in the prior art, methods and apparatus according to example embodiments of the invention are provided.

In some example embodiments, there is provided a method, comprising: receiving highlights and/or annotations in at least one electronic document made by at least one user; extracting keywords from the respective at least one electronic document with the highlights and/or annotations as tags of the respective at least one electronic document; and using the keywords as tags of the respective at least one electronic document to provide personalized contents from the at least one electronic document to a user.

In a further example embodiment, the using the keywords as tags of the at least one electronic document to provide personalized contents from the at least one electronic document to a user comprises: in response to a user's request for an electronic document, providing to the user a user interface control in association with the electronic document with highlights and/or annotations, the user interface control configured to enable the user to select a threshold, so that only those keywords of the electronic document with highlights and/or annotations having importance scores above the threshold are presented to the user.

In another further example embodiment, the method further comprises: creating user profiles including the extracted keywords from highlighted parts and/or annotations in the at least one electronic document made by the respective users; wherein the using the keywords as tags of the at least one electronic document to provide personalized contents from the at least one electronic document to a user comprises: for at least one keyword in the user profile of the user, calculating recommendation scores for the at least one electronic document based on the importance scores of the at least one keyword in the respective at least one electronic document; ranking the at least one electronic document by their recommendation scores; and recommending a predetermined number of electronic documents in the at least one electronic documents with the highest recommendation scores to the user.

In some other example embodiments, there is provided an apparatus, comprising: at least one processor; and at least one memory including computer program code, the at least one memory and the computer program code configured to, with the processor, cause the apparatus to at least: receive highlights and/or annotations in at least one electronic document made by at least one user; extract keywords from the respective at least one electronic document with the highlights and/or annotations as tags of the respective at least one electronic document; and use the keywords as tags of the respective at least one electronic document to provide personalized contents from the at least one electronic document to a user.

In a further embodiment, to use the keywords as tags of the at least one electronic document to provide personalized contents from the at least one electronic document to a user comprises: in response to a user's request for an electronic document, to provide to the user a user interface control in association with the electronic document with highlights and/or annotations, the user interface control configured to enable the user to select a threshold, so that only those keywords of the electronic document with highlights and/or annotations having importance scores above the threshold are presented to the user.

In another further embodiment, the at least one memory and the computer program code are further configured to, with the processor, cause the apparatus to: create user profiles including the extracted keywords from highlighted parts and/or annotations in the at least one electronic document made by the respective users; wherein to use the keywords as tags of the at least one electronic document to provide personalized contents from the at least one electronic document to a user comprises: for at least one keyword in the user profile of the user, to calculate recommendation scores for the at least one electronic document based on the importance scores of the at least one keyword in the respective at least one electronic document; to rank the at least one electronic document by their recommendation scores; and to recommend a predetermined number of electronic documents in the at least one electronic document with the highest recommendation scores to the user.

In some other example embodiments, there is provided a computer program product comprising at least one computer-readable storage medium having computer-executable program code instructions stored therein, the computer-executable program code instructions comprising program code instructions for: receiving highlights and/or annotations in at least one electronic document made by at least one user; extracting keywords from the respective at least one electronic document with the highlights and/or annotations as tags of the respective at least one electronic document; and using the keywords as tags of the respective at least one electronic document to provide personalized contents from the at least one electronic document to a user.

In some other example embodiments, there is provided a user interface, comprising: a user interface control presented in association with an electronic document with highlights and/or annotations, wherein keywords extracted from the electronic document with highlights and/or annotations are recorded with their importance scores in association with the electronic document, the user interface control configured to enable a user to select a threshold, so that only those keywords in the electronic document with highlights and/or annotations having importance scores above the threshold are presented to the user.

In another example embodiment, there is provided a method, comprising: receiving highlights and/or annotations in at least one electronic document made by a user; extracting keywords from the respective at least one electronic document with the highlights and/or annotations as tags of the respective at least one electronic document; and creating a user profile including the extracted keywords from the highlighted parts and/or annotations in the at least one electronic document made by the user.

Thus, by having high quality/relevant tags from a plurality of users for a given document, we may better profile the document. Similarly, by having high quality and insightful tags that a user has given to a plurality of documents, we may better profile the user's interest and behavior. And by having better document and user profiling, we may better recommend the right documents to right users. In addition, we may offer more interesting UI features to improve user experience and engagement. Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE ACCOMPANYING DRAWINGS

The embodiments of the invention are illustrated by way of example, and not by way of limitation, in the figures of the accompanying drawings:

FIG. 1 is a diagram of a system capable of enriching social media to improve personalized user experience according to embodiments of the present invention;

FIG. 2 shows an exemplary user interface of the browser application presenting an electronic document together with the annotations and/or highlights and keywords;

FIG. 3 shows an exemplary popped-up window in which keywords related to the electronic document are displayed;

FIG. 4A-4D shows schematically and exemplarily adjusting the threshold to displaying different amounts of keywords (or words) in an electronic document.

FIG. 5 shows exemplarily such another popped-up window in which the reputation score of a user, the numbers of highlights and annotations made by the user are displayed;

FIG. 6 shows a block diagram of an apparatus for enriching social media to improve personalized user experience according to some embodiments of the present invention;

FIG. 7 shows a block diagram of an apparatus 700 for enriching social media to improve personalized user experience according to some other embodiments of the present invention;

FIG. 8 shows a flow diagram of a method 800 for enriching social media to improve personalized user experience according to some embodiments of the present invention; and

FIG. 9 shows a flow diagram of a method 900 for enriching social media to improve personalized user experience according to some other embodiments of the present invention.

### DETAILED DESCRIPTION OF EXAMPLE EMBODIMENTS

Examples of a method, apparatus, and computer program for enriching social media to improve personalized user experience are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form or omitted in order to avoid unnecessarily obscuring the embodiments of the invention. Like reference numerals refer to like elements throughout the description and drawings. The terms “data”, “contents”, “information”, and similar terms may be used interchangeably, according to some example embodiments of the present invention, to refer to data capable of being transmitted, received, operated on, rendered and/or stored.

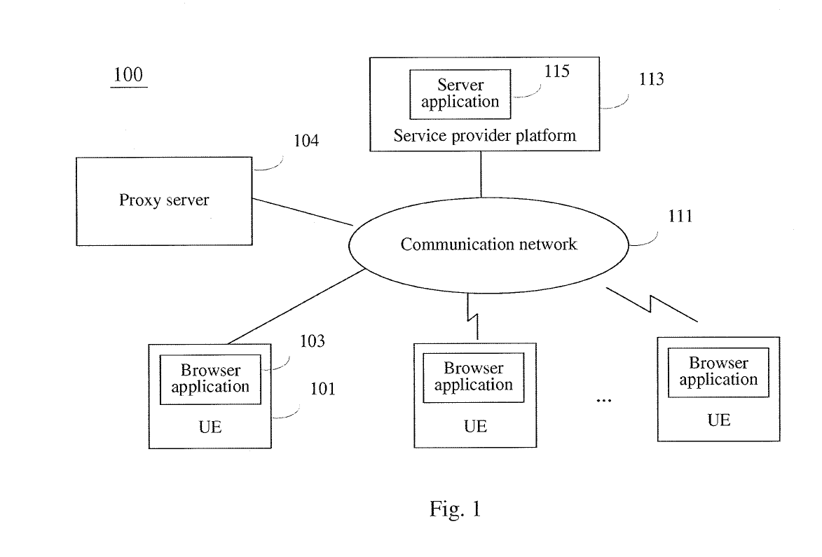

FIG. 1 is a diagram of a system capable of enriching social media to improve personalized user experience according to embodiments of the present invention. As shown in FIG. 1, the system 100 may comprise one or more user equipments (UE) 101 having connectivity to a service provider platform 113 via a communication network 111. By way of example, the communication network 111 of system 100 may include one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), a self-organized mobile network, or any other suitable packet-switched network, such as a commercially owned, proprietary packet-switched network, e.g., a proprietary cable or fiber-optic network. In addition, the wireless network may be, for example, a cellular network and may employ various technologies including Enhanced Data Rates for Global Evolution (EDGE), General Packet Radio Service (GPRS), Global System for Mobile Communications (GSM), Internet Protocol Multimedia Subsystem (IMS), Universal Mobile Telecommunications System (UMTS), etc., as well as any other suitable wireless medium, e.g., Worldwide Interoperability for Microwave Access (WiMAX), Wireless Local Area Network (WLAN), Long Term Evolution (LTE) networks, Code Division Multiple Access (CDMA), Wideband Code Division Multiple Access (WCDMA), Wireless Fidelity (WiFi), satellite, Mobile Ad-hoc Network (MANET), and the like.

The UE 101 may be any type of mobile terminal, fixed terminal, or portable terminal, including a mobile handset, station, unit, device, multimedia computer, multimedia tablet, Internet node, communicator, desktop computer, laptop computer, notebook computer, netbook computer, tablet computer, Personal Digital Assistants (PDAs), or any combination thereof. As known by one skilled in the art, the UE 101 may comprise, for example, a processor, a memory storing programs to be executed by the processor, and various kinds and number of peripheral devices for storage, input/output and communication etc., such as, e.g., an external storage, keyboard or keypad, display or touch-screen, speaker, microphone, video camera, network interface card, transceiver etc., and one or more buses coupling the processor to the memory and the other devices.

As shown in FIG. 1, the UE 101 may be installed with and execute a browser application 103, among other programs typically installed and executed within a mobile device or computing device. The browser application 103 may send a user's request for accessing internet contents such as a web page, the address of which the user input in the browser application in the form of a Uniform Resource Identifier, over the communication network 111 to a server application such as a web server, receive the contents of the web page from the server application as a response to the user's request, and then display the web page in a user interface, such as a screen of the user equipment 101. The browser application 103 may be any known web browser, such as Microsoft Corporation's Firefox and Internet Explorer, Apple Inc.'s Safari, or Google Inc.'s Chrome, or any newly-developed web browser.

As known by one skilled in the art, internet contents received from a server application and displayed in the UE may be various forms of digital contents, such as web pages, blogs, emails, micro-blogs, instant messages, Short Message Service (SMS) messages, postings in a social media such as a social networking site, etc. The units in which these internet contents may be stored, transmitted, processed or displayed may be referred to as documents, and therefore these internet contents may be generally referred to as electronic documents herein.

In embodiments of the present invention, the browser application 103 may be enhanced with the capability of receiving annotations and highlights made by a user in an electronic document displayed in the user interface of the UE 101, and sending the annotations and highlights to the service provider platform 113 over the communication network 111. This enhancement may be realized either by a plug-in with this capability to an existing browser application, or by a newly-developed browser application with this capability.

The browser application 103 may allow the user to highlight any parts, such as passages, sentences, phrases or words, in the displayed electronic document by any appropriate means. For example, in case the UE 101 is a desktop computer, the user may be allowed to first select a part of the electronic document using a mouse, and then to click a button to highlight it; or to first click a button to enter a highlight mode, and then select a part of the electronic document using a mouse to highlight it. As another example, in case the UE 101 is a smart phone or tablet computer with a touch screen, the user may be allowed to first tap a button to enter a highlight mode, and then to select a part of the electronic document by a swiping action to highlight it. When the user highlights a part of an electronic document, the browser application 103 may further provide some kind of visual indication to the highlight in the user interface of the UE 101, such as underlining the highlighted part or changing the background color of the highlighted part of the electronic document.

The browser application 103 may further allow the user to make annotations in the electronic document with respect to any highlighted part or any other part of the electronic documents, or with respect to the whole electronic document. The browser application 103 may allow the user to make annotations in any position in the electronic document by any appropriate means. For example, the browser application 103 may provide in the browser window a button, the clicking of which would display a text input box in which the user may input annotations. And the input annotation may be displayed at the cursor position in the electronic document.

After receiving the highlights and/or annotations made by the user in the electronic document, the browser application 103 may send the highlights and/or annotations to the service provider platform 113, possibly together with the electronic document.

It is to be noted that, in embodiments of the present invention, apart from the capability of receiving annotations and highlights made by the user in an electronic document, and sending the annotations and highlights to the service provider platform 113, the browser application 103 may have the functions related to accessing internet contents of a normal browser application. Thus, the user may use the browser application 103 as a normal browser application to access any internet contents on the Internet such as various web pages on various web servers and display the web pages in the user interface of the UE 101; and then the user may make annotations and/or highlights in the web pages and send the annotations and/or highlights, possibly together with the web pages, to the service provider platform 113.

The service provider platform 113 may comprise one or more computing devices of various architectures with sufficient computing, storage and communication capabilities and installed with appropriate software applications. Such computing devices may comprise, for example, processors, memories storing programs to be executed by the processor, and various kinds and number of peripheral devices for storage and communication etc., such as, e.g., external storage and network interface cards, and buses coupling the processors to the memories and the other devices.

In some embodiments of the present invention, the service provider platform 113 may be installed with and execute a server application 115 such as a web server, which may receive a user's request from the browser application 103 on the UE 101 for accessing an electronic document, acquire the electronic document from the storage of the service provider platform 113 or other devices, and send the electronic document to the browser application 103 as a response. The server application 115 may also communicate with applications on other service provider platforms or various other server computers (not shown) on the communication network such as the Internet to acquire electronic documents.

The communication between the UE 101 and the service provider platform 113 may use any known standardized protocol stack for data communication, such as Transmission Control Protocol/Internet Protocol (TCP/IP), Hypertext Transfer Protocol (HTTP), Hypertext Markup Language (HTML), Extensible Markup Language (XML), etc., or any newly-developed protocols.

In embodiments of the present invention, a server application 115 on the service provider platform 113 may be enhanced with the capabilities of receiving the highlights and/or annotations possibly together with the electronic document from the browser application 103 and of processing the received highlights and/or annotations in the way as described below. These capabilities may be realized either by add-on new modules for the receiving and processing to an existing server application such as a web server application on the service provider platform 113, or by a newly-developed server application 115 on the service provider platform 113 with the modules for the receiving and processing.

In some embodiments of the present invention, the capabilities of receiving the highlights and/or annotations may also be implemented in a proxy server. As known by one skilled in the art, a proxy sever may act as an intermediary device between UEs 101 and the service provider platform 113 or other web servers, receiving requests for accessing electronic documents from UEs 101, communicating with the service provider platform 113 or other web servers via the communication network 111 for acquiring the electronic documents, possibly adapting the acquired electronic documents to the specific UEs 101, and providing the possibly adapted electronic documents to the UEs 101. And as known by one skilled in the art, the proxy server may generally be implemented in a computing device comprising at least a processor, a memory storing programs to be executed by the processor, various other peripheral devices for storage and communication etc., and one or more buses coupling the processor to the memory and the other devices.

After receiving the highlights and/or annotations possibly together with the electronic document from the browser application 103, the server application 115 may extract keywords from the highlighted parts and annotations as well as other parts in the electronic document. These keywords presumably represent the most important points of the electronic document, and may be used as tags of the electronic document for the user. It is to be noted that keywords herein may also refer to key phrases.

Various keyword extraction algorithms may be used to extract keywords from the electronic document with the highlights and/or annotations. In some embodiments of the present invention, a Term Frequency-Inverse Document Frequency (TF-IDF)—like algorithm is used to extract keywords from the electronic document. The basic idea of this algorithm is to calculate the importance score of a word in an electronic document based on the occurrence frequency of the word in the electronic document (e.g., the number of occurrences of the word in the electronic document relative to the number of occurrences of all the words in the electronic document) relative to the occurrence frequency of the electronic documents including the word in a body of electronic documents (e.g., a training body of electronic documents); and then to select a predetermined number of words with the highest importance scores as keywords of the electronic document. According to this algorithm, the more frequently a word occurs in an electronic document, the more important the word is in the electronic document; however, the more frequently the word also occurs in other electronic documents, the less important the word is in the electronic document. In an embodiment of the present invention, the importance score of a word in the electronic document may be calculated simply as the occurrence frequency of the word in the electronic document divided by the occurrence frequency of the electronic documents including the word in a body of electronic documents (e.g., all the electronic documents in the service provider platform 113 or all the electronic documents accessible to the service provider platform 113). Of course, the importance score of a keyword may also be calculated in any other ways, as long as the calculated importance score of a word can represent the relative importance of the word in an electronic document to some extent. It is to be noted that, since the service provider platform 113 may receive electronic documents with annotations and/or highlights from many UEs 101, over time the service provider platform 113 may have collected a vast amount of electronic documents with annotations and/or highlights, which may be used as the training body of electronic documents for calculating the importance score of a word in the current electronic document, and for other purposes, such as for calculating the recommendation score for an electronic document as described below.

In calculating the occurrence frequency of a word in the electronic document with highlights and/or annotations, the occurrences of the word in the highlighted parts of the electronic document, in the annotations, and in other parts of the electronic document may be treated equally, i.e., having the same weight. Alternatively, they may have different weights in calculating the occurrence frequency. For example, the occurrences of the word in the highlighted parts of the electronic document and in the annotations may be given a higher weight than the occurrences of the word in other parts of the electronic document in counting the occurrence frequency. Even further, for example, the occurrences of the word in other parts of the electronic document may have no weight at all, that is, only the occurrences of a word in the highlighted parts and annotations are counted to calculate the occurrence frequency of the word in the electronic document.

In extracting keywords from the electronic document, the server application 115 may additionally focus on nouns, excluding words of other parts of speech from consideration. And the server application 115 may further use stemming to combine different variations of the same base word.

In some embodiments of the present invention, it is also contemplated that the user at the UE 101 may directly input keywords with respect to the electronic document, and the browser application 103 may send the input keywords together with the highlights and/or annotations and possibly the electronic document to the server application 115 on the service provider platform 113 over the communication network 111. Thus, the server application 115 may have both the keywords extracted from the electronic document with the highlights and/or annotations, and the received keywords directly input by the user. In such embodiments, the browser application 103 may provide in the browser window a button, the clicking of which would display a text input box in which the user may input keywords.

After extracting the keywords from the electronic document and/or receiving the keywords input directly by the user from the browser application 103, the server application 115 may store the keywords in association with the electronic document, the highlighted parts, other parts or annotations from which the keywords were extracted, and the user ID or user name, for example, in a database on a storage device associated with the service provider platform 113. Since a single electronic document may be accessed, annotated and/or highlighted by many users using many UEs 101, and a single user may access, annotated and/or highlighted many electronic document using his/her UE 101, over time the server application may store a vast amount of data on electronic documents with annotations and/or highlights made by many users as well as extracted keywords in the database. These data may be stored in the database in an organized and structured way (e.g., in relational database tables) such that given any one of electronic documents, annotations and/or highlights, users, and keywords, all the related others of electronic documents, annotations and/or highlights, users and keywords can be obtained. Thus, from this vast amount of data, we can obtain electronic documents enriched with the social wisdom of many users in the form of annotations and/or highlights made by them, as well as keywords extracted by the system and input directly by the users. From these annotations and/or highlights and keywords, a much more thorough understanding of the contents of the electronic document per se and related topics may be achieved in a much shorter time. Moreover, from this vast amount of data, we can know all the electronic documents accessed and the annotations and/or highlights made by a specific user, as well as keywords extracted from annotations and/or highlighted parts and other parts of these electronic documents, and keywords input directly by the specific user, thus being able to profile the user accurately.

This vast amount of data of a high quality may be utilized in various ways for various purposes, such as profiling users, recommendation of electronic documents to users, presenting highly enriched view of electronic documents to users, etc.

In some embodiments of the present invention, this vast amount of data may be utilized to present an enriched view of contents of an electronic document to a user. That is, when a user uses a browser application 103 on his/her UE 101 to access an electronic document stored at the service provider platform 113 through the server application 115, the server application may send the electronic document together with all the annotations and/or highlights made by users, as well as the keywords extracted and/or input directly by users in association with the electronic document to the UE 101, to be presented by the browser application 103 to the user. The browser application 103 may present the electronic document together with the annotations and/or highlights as well as the keywords to the user in various ways. For example, the browser application 103 may first present the original electronic document provided with a pop-up menu (which may be activated and displayed by pressing on the text of the electronic document or by other means), in which the user may select menu items to view highlighted parts made by users, to view annotations made by users, and to view keywords.

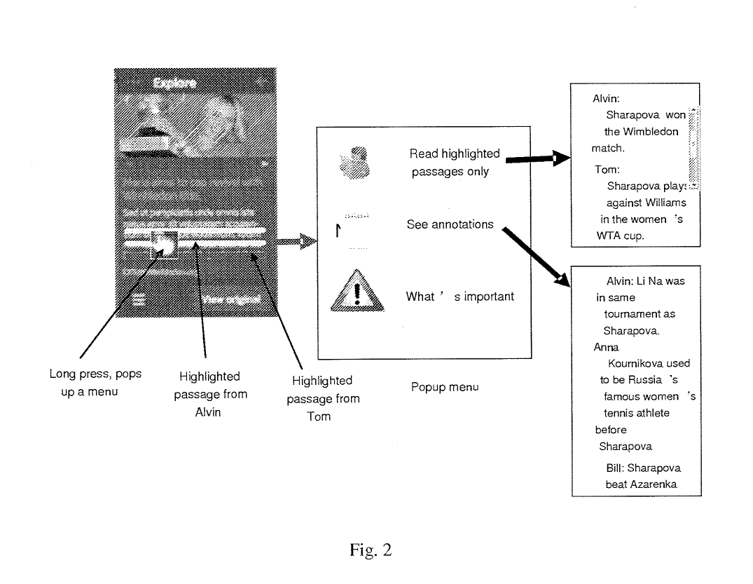

Referring to FIG. 2, it shows an exemplary user interface of the browser application 103 presenting an electronic document together with annotations and/or highlights and keywords. As shown, the original electronic document is presented in the user interface, and highlighted passages made by different users are marked in the presented original electronic document with different colors (the highlighted passages may also not be marked for cleanness of the page, especially when many users have highlighted parts of the electronic documents). When the user long presses on the text of the electronic document, a pop-up menu would be presented with menu items labeled as “Read highlighted passages only”, “See annotations”, and “What's important”, respectively. When the user next clicks on the menu item “Read highlighted passages only”, a window would be popped up, in which the highlighted passages made by different users would be displayed; when the user clicks on the menu item “See annotations”, a window would be popped up, in which the annotations made by different users would be displayed; and when the user clicks on the menu item “What's important”, a window would be popped up, in which keywords related to the electronic document would be displayed.

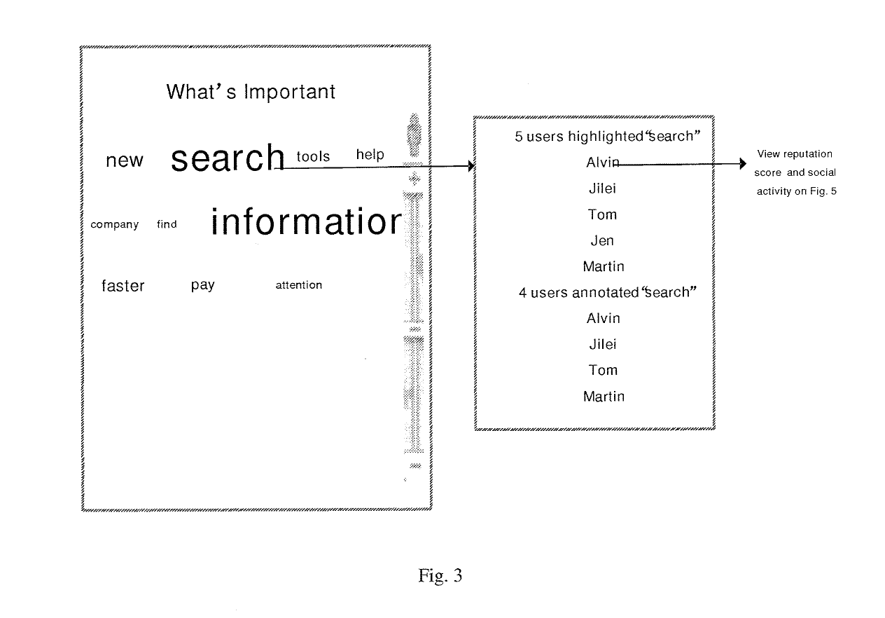

Referring to FIG. 3, it shows an exemplary popped-up window in which keywords related to the electronic document are displayed. As shown, in the popped-up window, different keywords related to the electronic document may be displayed. As further shown, optionally, different keywords may be displayed in different font sizes, with the bigger font size of a keyword representing that the keyword has the greater importance score as described above. As still further shown, the window may be provided with a scroll bar (or any other appropriate user interface control) by which the user may select a threshold of importance score for displaying keywords; that is, when the user uses the scroll bar to select a threshold, only the keywords with the importance scores greater than the threshold would be displayed in the window, while the keywords with the importance scores less than the threshold would not be displayed in the window. In this way, the user may conveniently control the quantity of keywords related to the electronic document to be shown based on the importance of the keywords. The user may first select to view the most important keywords of the electronic document, and then gradually select to additionally view less and less important keywords of the electronic document, until finally to view all the keywords of the electronic document. Thus, the keywords would acquire an additional dimension of importance. It is like that the keywords become three-dimensional ones with two dimensions in the screen plane, and an additional dimension of height above the screen plane, with the additional dimension of height actually representing the importance scores of the keywords. It is also like that for rocks with different heights in a body of water, when the water level becomes lower and lower, more and more rocks emerge, until finally all the rocks in the water emerge, presenting a complete view of the scene of rocks.

In some other embodiments of the present invention, the scroll bar (or any other appropriate user interface control) may be used to select a threshold of other statistics related to keywords than the importance scores to control the amount of keywords to be displayed in the user interface. Theses other statistics may be, for example, the number of times the keywords were accessed, highlighted or annotated by different users. Optionally, these other statistics may be further weighted by users' social reputations as described below. Thus, when the user selects a threshold using the scroll bar, only those keywords with the other statistics greater than the threshold are displayed in the user interface. In such embodiments, of course, these other statistics should have been stored in association with the keywords in the service provider platform 113 in advance and sent to the browser application 115 on the UE 101 possibly along with the electronic document.

In some other embodiments of the present invention, the scroll bar (or any other appropriate user interface control) may be used to control the display of all the words in the electronic document, instead of only the keywords in the electronic document. That is, when the user uses the scroll bar to select a threshold of importance score or other statistics, those words in the electronic document with the importance scores or other statistics greater than the threshold may be displayed in the user interface. In such embodiments, of course, the importance scores or the other statistics of all the words in the electronic document should have been stored in association with the words in the service provider platform 113 in advance and sent to the browser application 115 on the UE 101 possibly along with the electronic document.

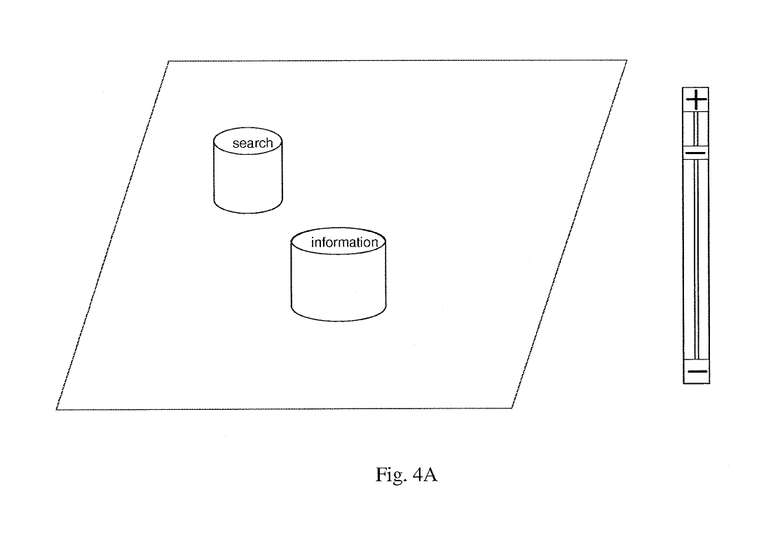

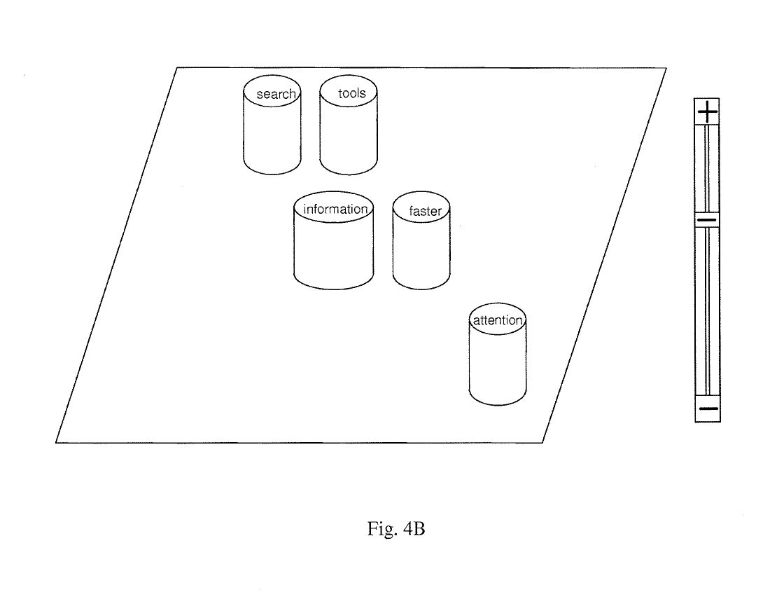

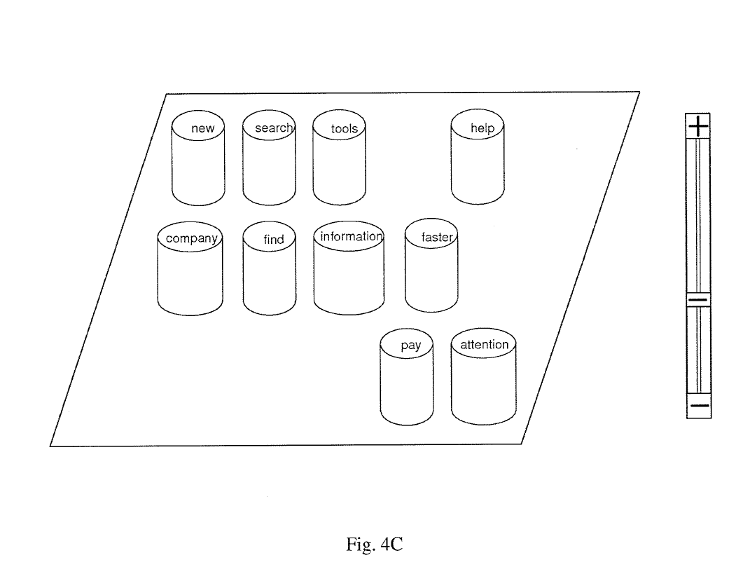

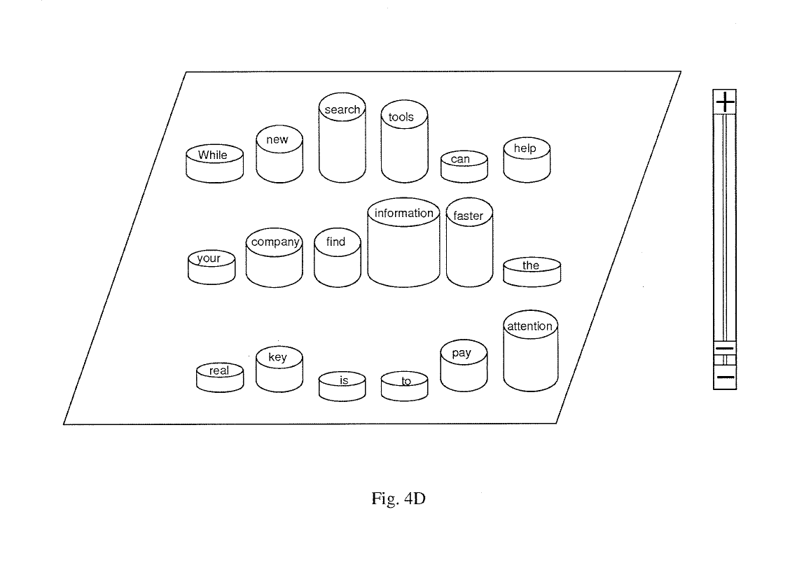

FIG. 4A-4D shows schematically and exemplarily adjusting the threshold to display different amounts of keywords (or words) in an electronic document. As shown, from FIG. 4A to FIG. 4D, when the threshold becomes lower and lower by using the scroll bar, more and more keywords (or words) are displayed in the user interface.

Returning to FIG. 3, in some further embodiments of the present invention, the keywords displayed in the popped-up window may be configured that, when one of the keywords is clicked or tapped, a separate window in which the names or IDs of all the users that have highlighted or annotated the keyword are listed may be popped up. As known by one of skilled in the art, just for example, this may be realized by sending the keyword from the browser application 103 to the server application 115, which uses the keyword to query the database storing keywords in association with the electronic documents, the highlighted parts, other parts or annotations from which the keywords were extracted, and the user IDs or user names in the service provider platform 113 to find the corresponding user IDs or user names, and then receiving the found user IDs or user names from the server application 115 and displaying the user IDs or user names in the separate popped-up window.

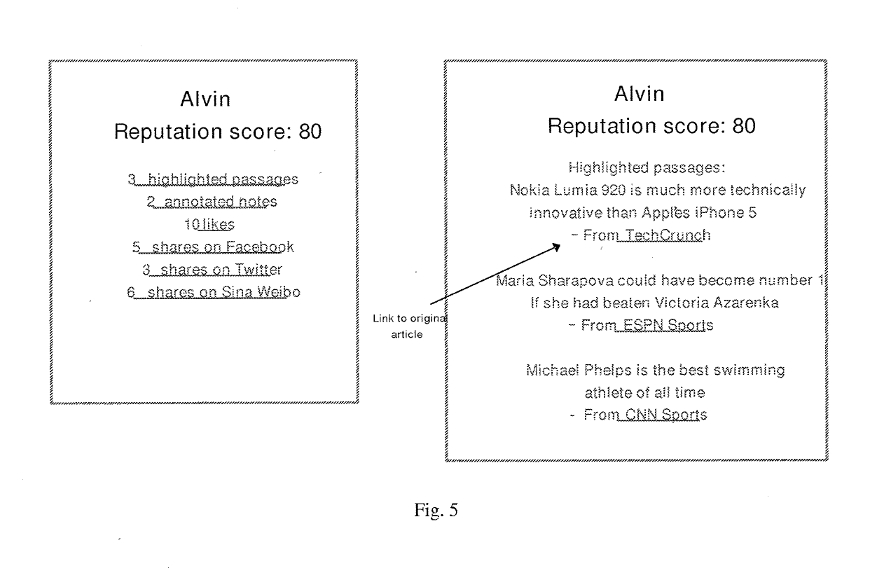

In some still further embodiments of the present invention, the user names or IDs displayed in the separate popped-up window may be configured that, when one of the user names or IDs is clicked or tapped, the reputation score of the user, the highlights and annotations made by the user may be displayed, possibly in another popped up window. FIG. 5 shows exemplarily such another popped-up window in which the reputation score of a user, and the numbers of highlights and annotations made by the user are displayed. The reputation score of a user reflects the degree of participation of the user in social activities, and it may be calculated in various ways. For example, it may be calculated as the sum or a weighted sum of the numbers of highlights and annotations made by the user. Optionally, it may also take into account other social activities made by the user, such as likes and shares made by the user on other social media such as Facebook, Twitter, and Sina Weibo, etc. In such embodiments, the reputation scores of users may have to be calculated and stored in association with the user IDs or user names in the service provider platform 113 in advance; and when a user name or ID is clicked or tapped in the separate popped-up window, the user name or user ID is sent from the browser application 103 to the server application 115, which uses the user name or user ID to find the reputation score of the user, as well as the highlights and annotations made by the user, and sends them back to the browser application 103 to be displayed in the another popped up window.

As shown in FIG. 5, when the number of highlights or the number of annotations displayed in the another popped-up is clicked or tapped, all the highlighted passages or all the annotations made by the user are displayed, possibly in a further popped-up window; and optionally, links to the original electronic documents of the highlighted passages and annotations may be further provided in the further popped-up window.

While above are described embodiments of the present invention in which the vast amount of data on highlights and/or annotations made on electronic documents by different users are utilized to present enriched view of contents of an electronic document to a user, in some other embodiments of the present invention, this vast amount of data may be utilized to create a user profile for a user, and further to recommend electronic documents to the user.

In some embodiments of the present invention, the keywords extracted from the highlighted parts and/or annotations in different electronic documents made by a user may be used to create a user profile of the user. The user profile may include the keywords the user has annotated and/or highlighted (i.e., the keywords extracted from the highlighted parts and annotations related to electronic documents made by the user) and possibly the keyword input directly by the user, and thus reflects the user's preferences, interests, likes, etc. The created user profiles of various users may be stored in association with the user names or user IDs in the service provider platform 113. The user profiles may be utilized for various purposes.

In some embodiments of the present invention, the user profile including the keywords highlighted and/or annotated by a user may be utilized to recommend electronic documents for the user. Specifically, for at least one keyword (e.g., each keyword) in the user profile of the user, recommendation scores for different electronic documents in a body of electronic documents may be calculated based on the importance scores (as described above) of the keyword in the respective electronic documents; then the different electronic documents may be ranked by their recommendation scores; and finally a predetermined number of electronic documents with the highest recommendation scores may be recommended to the user.

In calculating the recommendation scores for different electronic documents, and inspired by Bayesian inference, the following formula may be used:

For a given k-th electronic document Dₖ and i-th keyword kwᵢ, let

p(Dₖ|kwᵢ)=p(kwᵢ|Dₖ)*p(Dₖ)/p(kwᵢ) (1)

wherein, p(Dₖ|kwᵢ) is the recommendation score of electronic document Dₖ for keyword kwᵢ, p(kwᵢ|Dₖ) is the importance score of keyword kwᵢ in electronic document Dₖ, p(Dₖ) is the occurrence frequency of electronic document Dₖ in all the electronic documents in a body of electronic documents, and p(kwᵢ) is the occurrence frequency of keyword kwᵢ in all the keywords in the body of electronic documents, and p(Dₖ) and p(kwᵢ) can be expressed as:

$$\begin{matrix}p ( {D}_{k} ) = \frac{count ( {D}_{k} )}{\sum count ( {D}_{j} )} & ( 2 ) \\ p ( {kw}_{i} ) = \frac{count ( {kw}_{i} )}{\sum count ( {kw}_{t} )} & ( 3 )\end{matrix}$$

wherein, count(Dₖ) is the number of occurrences of Dₖ in the body of electronic documents, Σcount(Dⱼ) is the sum of the numbers of occurrences of all the electronic documents in the body of electronic documents, count(kwᵢ) is the number of occurrences of kwᵢ in the body of electronic documents, and Σcount(kwₜ) is the sum of the numbers of occurrences of all the keywords in the body of electronic documents.

Since the Σcount(Dⱼ) and Σcount(kwₜ) are assumed to be constant for all the electronic documents and all the keywords, their relationship can be expressed as:

Σcount(kwₜ)=λΣcount(Dⱼ) (4)

wherein, λ, is a normalization factor.

From the equations (1)-(4), we can get:

p(Dₖ|kwᵢ)=p(kwᵢ|Dₖ)*count(Dₖ)/count(kwᵢ)·λ (5)

Thus, from equation (5), for each of one or more keywords in the user profile, the recommendation scores for all the electronic documents in the body of electronic documents may be calculated (since λ is a constant for all the electronic documents and keywords, and the recommendation scores are only used for ranking, λ may be omitted from the equation (5) when calculating the recommendation scores), then the electronic documents may be ranked by the recommendation score, and a predetermined number of electronic documents with the highest recommendation scores for each keyword may be selected. The predetermined number of electronic documents with the highest recommendation scores for different keywords may be simply combined together, as a group of electronic documents to be recommended to the user and displayed in the user interface of the UE 101 of the user; or a selection of electronic documents may be further determined from the predetermined number of electronic documents with the highest recommendation scores for different keywords, for example, according to whether an electronic document is present in the predetermined numbers of electronic documents with the highest recommendation scores for more than one keywords, etc.

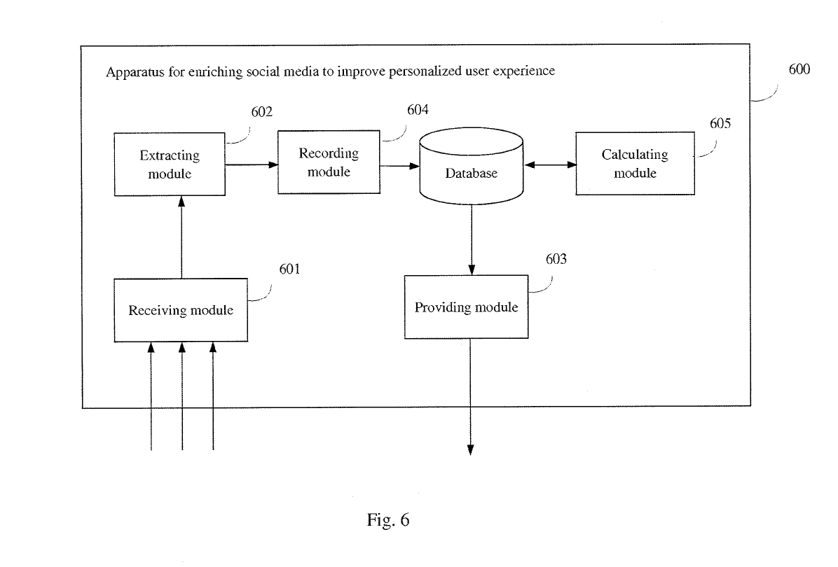

Above having described a system capable of enriching social media to improve personalized user experience according to embodiments of the present invention with reference to the drawings FIG. 1-5, now referring to FIG. 6, it shows a block diagram of an apparatus 600 for enriching social media to improve personalized user experience according to some embodiments of the present invention.

As shown, the apparatus 600 may comprise the following modules: a receiving module 601 configured to receive highlights and/or annotations in at least one electronic document made by at least one user;

an extracting module 602 configured to extract keywords from the respective at least one electronic document with the highlights and/or annotations as tags of the respective at least one electronic document; and

a providing module 603 configured, in response to a user's request for an electronic document, to provide an electronic document to the user together with a user interface control, the user interface control configured to enable the user to select to be presented at least one of the following: highlighted parts of the electronic document marked by users, annotations in the electronic document made by users; and extracted keywords from the electronic document.

According to an embodiment of the present invention, the receiving module 601 may be further configured to receive keywords input by the at least one user as additional tags of the respective at least one electronic document.

According to an embodiment of the present invention, the extracting module 602 may comprise:

a calculating sub-module configured, for an electronic document in the respective at least one electronic document, to calculate an importance score of each word in the electronic document with highlights and/or annotations as the occurrence frequency of the word in the electronic document with highlights and/or annotations relative to the occurrence frequency of the electronic documents including the word in a body of electronic documents; and

an identifying sub-module configured to identify a predetermined number of words with the highest importance scores in the electronic document with highlights and/or annotations as the keywords of the electronic document;
wherein the apparatus 600 may further comprise:
a recording module 604 configured to record the extracted keywords with their importance scores in association with the respective at least one electronic document, the highlighted parts and/or annotations in the respective at least one electronic documents from which they were extracted, and the users making the highlights and/or annotations.

According to a further embodiment of the present invention, the occurrence frequency of the word in the electronic document with highlights and/or annotations may comprise a weighted sum of the occurrence frequencies of the word in the annotations and/or in the highlighted parts and in the other parts of the electronic document.

According to an embodiment of the present invention, the providing module 603 may be configured, in response to a user's request for an electronic document, provide to the user a user interface control in association with an electronic document with highlights and/or annotations, the user interface control configured to enable the user to select a threshold, so that only those keywords of the electronic document with highlights and/or annotations having importance scores above the threshold are presented to the user.

According to a further embodiment of the present invention, the apparatus 600 may further comprise:
a calculating module 605 configured to calculate reputation scores for the respective users based on the highlights and/or annotations they made in the respective at least one electronic document;

wherein, those keywords presented to the user may be configured so that, when one of those keywords is clicked or tapped by the user, the identifiers of all the users that have highlighted or annotated the keyword are presented, and

wherein, the identifiers of the users presented may be configured so that, when one of the identifiers of the users is clicked or tapped, the reputation score of the user with the identifier is presented, together with links to the highlighted parts and/or annotations made by the user with the identifier.

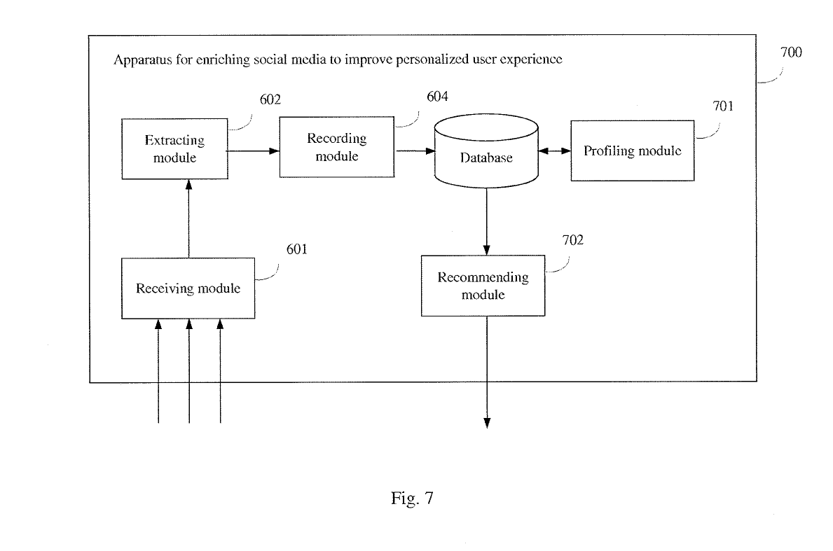

Now referring to FIG. 7, it shows a block diagram of an apparatus 700 for enriching social media to improve personalized user experience according to some other embodiments of the present invention.

As shown, the apparatus 700 may comprise the following modules:

a receiving module 601 configured to receive highlights and/or annotations in at least one electronic document made by at least one user;

an extracting module 602 configured to extract keywords from the respective at least one electronic document with the highlights and/or annotations as tags of the respective at least one electronic document; and

a recording module 604 configured to record the extracted keywords with their importance scores in association with the respective at least one electronic document, the highlighted parts and/or annotations in the respective at least one electronic documents from which they were extracted, and the users making the highlights and/or annotations;

a profiling module 701 configured to create user profiles including the extracted keywords from highlighted parts and/or annotations in the at least one electronic document made by the respective users; and

a recommending module 702 comprising:

a calculating sub-module configured, for at least one keyword in the user profile of the user, to calculate recommendation scores for the at least one electronic document based on the importance scores of the at least one keyword in the respective at least one electronic document;

a ranking sub-module configured to rank the at least one electronic document by their recommendation scores; and

a recommending sub-module configured to recommend a predetermined number of electronic documents in the at least one electronic document with the highest recommendation scores to the user.

According to an embodiment of the present invention, the calculating sub-module may be further configured, for a keyword in the user profile of the user, to calculate a recommendation score for an electronic document as the multiplication of the importance score of the keyword in the electronic document and the number of occurrences of the electronic document in the body of electronic documents divided by the number of occurrences of the keyword in the body of electronic documents.

As indicated by the use of the same reference numerals, the receiving module 601, extracting module 602 and the recording module 604 in the apparatus 700 may be the same as those in the apparatus 600, performing the same functions and having the same variations in various embodiments of the present invention, which, for the sake of simplicity, are not repeated here.

As known by one skilled in the art, the apparatuses 600 and 700 may be implemented in any one or a combination of a service provider platform, a UE, a proxy server, or any other device. And generally, they may be implemented in a computing device comprising at least one processor, and at least one memory including computer program code, the at least one memory and the computer program code configured to, with the processor, cause the device to perform the functions of the apparatus 600 or 700, and to form the modules of the apparatus 600 or 700. It is further to be noted that the above description of the apparatuses 600 and 700 are only exemplary, rather than limitation to the scope of the present invention. In other embodiments of the present invention, the apparatuses 600 and 700 may have more, less or different modules, and the relationships of inclusion, connection and function among the modules may be different from described.

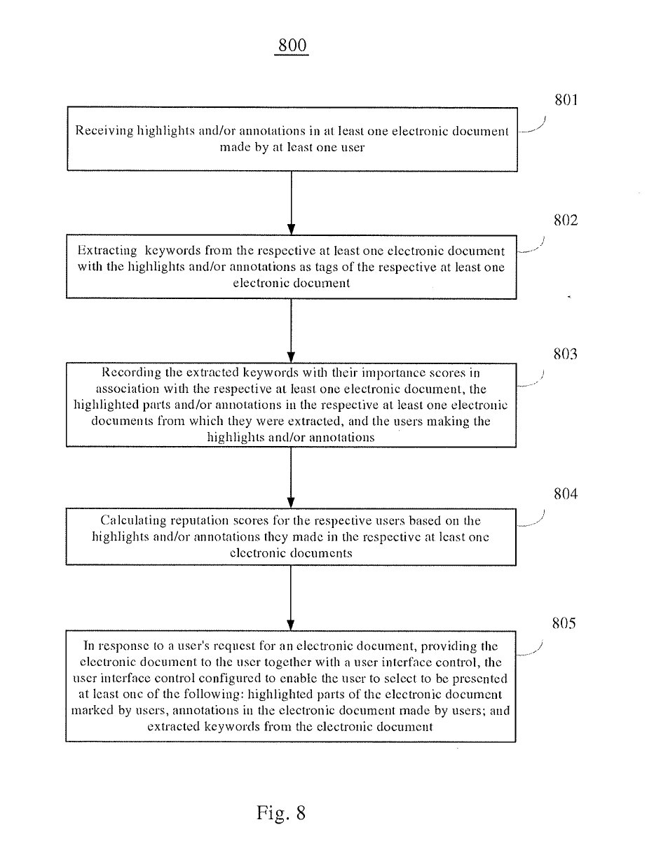

Referring to FIG. 8, it shows a flow diagram of a method 800 for enriching social media to improve personalized user experience according to some embodiments of the present invention.

As shown, the method 800 may comprise the following steps:

in step 801, highlights and/or annotations in at least one electronic document made by at least one user may be received.

in step 802, keywords may be extracted from the respective at least one electronic document with the highlights and/or annotations as tags of the respective at least one electronic document.

in step 805, in response to a user's request for an electronic document, the electronic document may be provided to the user together with a user interface control, the user interface control configured to enable the user to select to be presented at least one of the following: highlighted parts of the electronic document marked by users, annotations in the electronic document made by users; and extracted keywords from the electronic document.

In an embodiment of the present invention, the method 800 may further comprise that:

in step 801, keywords input by the at least one user may be received as additional tags of the respective at least one electronic document.

In an embodiment of the present invention, the step 802 may further comprise the following sub-steps of:

for an electronic document in the respective at least one electronic document, calculating an importance score of each word in the electronic document with highlights and/or annotations as the occurrence frequency of the word in the electronic document with highlights and/or annotations relative to the occurrence frequency of the electronic documents including the word in a body of electronic documents; and identifying a predetermined number of words with the highest importance scores in the electronic document with highlights and/or annotations as the keywords of the electronic document;

wherein the method may further comprise the following step:

in step 803, the extracted keywords with their importance scores may be recorded in association with the respective at least one electronic document, the highlighted parts and/or annotations in the respective at least one electronic documents from which they were extracted, and the users making the highlights and/or annotations.

In a further embodiment of the present invention, the occurrence frequency of the word in the electronic document with highlights and/or annotations may comprise a weighted sum of the occurrence frequencies of the word in the annotations and/or in the highlighted parts and in the other parts of the electronic document.

In an embodiment of the present invention, the method 800 may further comprise that:

in the step 805, in response to a user's request for an electronic document, the user may be provided a user interface control in association with the electronic document with highlights and/or annotations, the user interface control configured to enable the user to select a threshold, so that only those keywords of the electronic document with highlights and/or annotations having importance scores above the threshold are presented to the user.

In an embodiment of the present invention, the method 800 may further comprise the following step:

in step 804, reputation scores for the respective users may be calculated based on the highlights and/or annotations they made in the respective at least one electronic document;

wherein, those keywords presented to the user may be configured so that, when one of those keywords is clicked or tapped by the user, the identifiers of all the users that have highlighted or annotated the keyword may be presented, and

wherein, the identifiers of the users presented may be configured so that, when one of the identifiers of the users is clicked or tapped, the reputation score of the user with the identifier may be presented, together with links to the highlighted parts and/or annotations made by the user with the identifier.

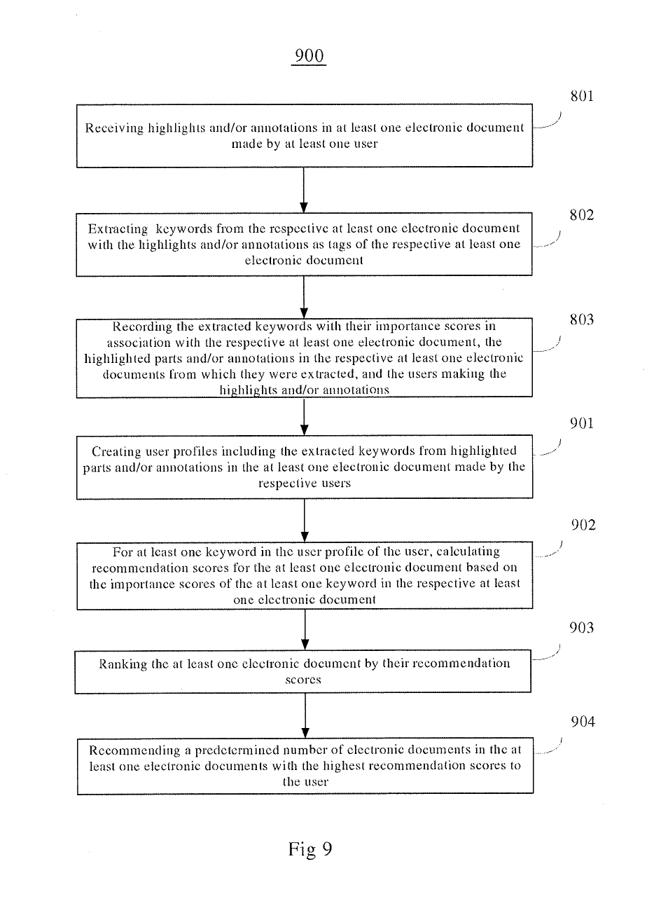

Referring to FIG. 9, it shows a flow diagram of a method 900 for enriching social media to improve personalized user experience according to some other embodiments of the present invention.

As shown, the method 900 may comprise the following steps:

in step 801, highlights and/or annotations in at least one electronic document made by at least one user may be received.

in step 802, keywords may be extracted from the respective at least one electronic document with the highlights and/or annotations as tags of the respective at least one electronic document.

in step 803, the extracted keywords with their importance scores may be recorded in association with the respective at least one electronic document, the highlighted parts and/or annotations in the respective at least one electronic documents from which they were extracted, and the users making the highlights and/or annotations;

in step 901, user profiles may be created including the extracted keywords from highlighted parts and/or annotations in the at least one electronic document made by the respective users.

in step 902, for at least one keyword in the user profile of the user, recommendation scores may be calculated for the at least one electronic document based on the importance scores of the at least one keyword in the respective at least one electronic document.

in step 903 the at least one electronic document may be ranked by their recommendation scores;

in step 904, a predetermined number of electronic documents in the at least one electronic document with the highest recommendation scores may be recommended to the user.

In an embodiment of the present invention, the step 902 may further comprise: for a keyword in the user profile of the user, calculating a recommendation score for the electronic document as the multiplication of the importance score of the keyword in the electronic document with the number of occurrences of the electronic document in the body of electronic documents divided by the number of occurrences the keyword in the at least one electronic document.

As indicated by the use of the same reference numerals, the steps 801, 802 and 803 of the method 900 may be the same as those of the method 800, performing the same operations and having the same variations in various embodiments of the present invention, which, for the sake of simplicity, are not repeated here.

As known by one skilled in the art, the methods 800 and 900 may be implemented in any one or a combination of a service provider platform, a UE, a proxy server, or any other device. And generally, they may be implemented in a computing device comprising at least one processor, and at least one memory including computer program code, the at least one memory and the computer program code configured to, with the processor, cause the device to perform the operations of the steps of the method 800 or 900. It is further to be noted that the above description of the methods 800 and 900 are only exemplary, rather than limitation to the scope of the present invention. In other embodiments of the present invention, the methods 800 and 900 may have more, less or different steps, and the relationships of inclusion, sequence and function among the steps may be different from described.

In some other embodiments of the preset invention, there is provided a computer program product comprising at least one computer-readable storage medium having computer-executable program code instructions stored therein, the computer-executable program code instructions comprising program code instructions for:

receiving highlights and/or annotations in at least one electronic document made by at least one user;

extracting keywords from the respective at least one electronic document with the highlights and/or annotations as tags of the respective at least one electronic document; and

using the keywords as tags of the respective at least one electronic document to provide personalized contents from the at least one electronic document to a user.

In some other embodiments of the present invention, there is provided a user interface, comprising:

a user interface control presented in association with an electronic document with highlights and/or annotations, wherein keywords extracted from the electronic document with highlights and/or annotations are recorded with their importance scores in association with the electronic document, the user interface control configured to enable a user to select a threshold, so that only those keywords in the electronic document with highlights and/or annotations having importance scores above the threshold are presented to the user.

In a further embodiment of the present invention, those keywords presented to the user are configured so that, when one of those keywords is clicked or tapped by the user, the identifiers of all the users that have highlighted or annotated the keyword are presented, and

wherein, the identifiers of the users presented are configured so that, when one of the identifiers of the users is clicked or tapped, the reputation score of the user with the identifier, calculated based on the highlights and/or annotations they made in the respective at least one electronic document, is presented, together with links to the highlighted parts and/or annotations made by the user with the identifier.

In some other embodiments of the present invention, there is provided a method, comprising the steps of:

receiving highlights and/or annotations in at least one electronic document made by a user;

extracting keywords from the respective at least one electronic document with the highlights and/or annotations as tags of the respective at least one electronic document; and

creating a user profile including the extracted keywords from the highlighted parts and/or annotations in the at least one electronic document made by the user.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

It should be appreciated that at least some aspects of the exemplary embodiments of the inventions may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

The present invention includes any novel feature or combination of features disclosed herein either explicitly or any generalization thereof. Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1. A method, comprising:
receiving highlights and/or annotations in at least one electronic document made by at least one user;
extracting keywords from the respective at least one electronic document with the highlights and/or annotations as tags of the respective at least one electronic document; and
using the keywords as tags of the respective at least one electronic document to provide personalized contents from the at least one electronic document to a user.

2. The method according to claim 1, further comprising:
receiving keywords input by the at least one user as additional tags of the respective at least one electronic document.

3. The method according to claim 1, wherein the extracting keywords from the respective at least one electronic document with the highlights and/or annotations as tags of the respective at least one electronic document comprises:
for an electronic document in the respective at least one electronic document, calculating an importance score of each word in the electronic document with highlights and/or annotations as the occurrence frequency of the word in the electronic document with highlights and/or annotations relative to the occurrence frequency of the electronic documents including the word in a body of electronic documents;
identifying a predetermined number of words with the highest importance scores in the electronic document with highlights and/or annotations as the keywords of the electronic document;
wherein the method further comprises:
recording the extracted keywords with their importance scores in association with the respective at least one electronic document, the highlighted parts and/or annotations in the respective at least one electronic documents from which they were extracted, and the users making the highlights and/or annotations.

4. The method according to claim 3, wherein the occurrence frequency of the word in the electronic document with highlights and/or annotations comprises a weighted sum of the occurrence frequencies of the word in the annotations and/or in the highlighted parts and in the other parts of the electronic document.

5. The method according to claim 1, wherein the using the keywords as tags of the respective at least one electronic document to provide personalized contents from the respective at least one electronic document to a user comprises:
in response to a user's request for an electronic document, providing the electronic document to the user together with a user interface control, the user interface control configured to enable the user to select to be presented at least one of the following: highlighted parts of the electronic document marked by users, annotations in the electronic document made by users; and extracted keywords from the electronic document.

6. The method according to claim 1, wherein the using the keywords as tags of the at least one electronic document to provide personalized contents from the at least one electronic document to a user comprises:
in response to a user's request for an electronic document, providing to the user a user interface control in association with the electronic document with highlights and/or annotations, the user interface control configured to enable the user to select a threshold, so that only the keywords of the electronic document with highlights and/or annotations having importance scores above the threshold are presented to the user.

7. The method according to claim 6, further comprising:
calculating reputation scores for the respective users based on the highlights and/or annotations they made in the respective at least one electronic documents;
wherein, the keywords presented to the user are configured so that, when one of the keywords is clicked or tapped by the user, the identifiers of all the users that have highlighted or annotated the keyword are presented, and
wherein, the identifiers of the users presented are configured so that, when one of the identifiers of the users is clicked or tapped, the reputation score of the user with the identifier is presented, together with links to the highlighted parts and/or annotations made by the user with the identifier.

8. The method according to claim 1, further comprising:
creating user profiles including the extracted keywords from highlighted parts and/or annotations in the at least one electronic document made by the respective users;
wherein the using the keywords as tags of the at least one electronic document to provide personalized contents from the at least one electronic document to a user comprises:
for at least one keyword in the user profile of the user, calculating recommendation scores for the at least one electronic document based on the importance scores of the at least one keyword in the respective at least one electronic document;
ranking the at least one electronic document by their recommendation scores; and

9. The method according to claim 8, wherein the calculating recommendation scores for the at least one electronic document based on the importance scores of the at least one keyword in the respective at least one electronic document comprises:
for a keyword in the user profile of the user, calculating a recommendation score for an electronic document as the multiplication of the importance score of the keyword in the electronic document and the number of occurrences of the electronic document in the body of electronic documents divided by the number of occurrences of the keyword in the body of electronic documents.

10. An apparatus, comprising:
at least one processor; and
at least one memory including computer program code,
the at least one memory and the computer program code configured to, with the processor, cause the apparatus to at least:
receive highlights and/or annotations in at least one electronic documents made by at least one users;
extract keywords from the respective at least one electronic documents with the highlights and/or annotations as tags of the respective at least one electronic documents; and
use the keywords as tags of the respective at least one electronic documents to provide personalized contents from the at least one electronic documents to a user.

11. The apparatus according to claim 10, wherein the at least one memory and the computer program code are further configured to, with the processor, cause the apparatus to:
receive keywords input by the at least one users as additional tags of the respective at least one electronic documents.

12. The apparatus according to claim 10, wherein to extract keywords from the respective at least one electronic documents with the highlights and/or annotations as tags of the respective at least one electronic documents comprises:
for an electronic document in the respective at least one electronic documents, to calculate an importance score of each word in the electronic document with highlights and/or annotations as the occurrence frequency of the word in the electronic document with highlights and/or annotations relative to the occurrence frequency of the electronic documents including the word in a body of electronic documents;
to identify a predetermined number of words with the highest importance scores in the electronic document with highlights and/or annotations as the keywords of the electronic document;
wherein the at least one memory and the computer program code further configured to, with the processor, cause the apparatus to
record the extracted keywords with their importance scores in association with the respective at least one electronic document, the highlighted parts and/or annotations in the respective at least one electronic documents from which they were extracted, and the users making the highlights and/or annotations.

13. The apparatus according to claim 12, wherein the occurrence frequency of the word in the electronic document with highlights and/or annotations comprises a weighted sum of the occurrence frequencies of the word in the annotations and/or in the highlighted parts and in the other parts of the electronic document.

14. The apparatus according to claim 10, wherein to use the keywords as tags of the respective at least one electronic document to provide personalized contents from the respective at least one electronic document to a user comprises:
in response to a user's request for an electronic document, to provide the electronic document to the user together with a user interface control, the user interface control configured to enable the user to select to be presented at least one of the following:
highlighted parts of the electronic document marked by users, annotations in the electronic document made by users; and extracted keywords from the electronic document.

15. The apparatus according to claim 10, wherein to use the keywords as tags of the at least one electronic document to provide personalized contents from the at least one electronic document to a user comprises:
in response to a user's request for an electronic document, to provide to the user a user interface control in association with the electronic document with highlights and/or annotations, the user interface control configured to enable the user to select a threshold, so that only the keywords of the electronic document with highlights and/or annotations having importance scores above the threshold are presented to the user.

16. The apparatus according to claim 15, wherein the at least one memory and the computer program code are further configured to, with the processor, cause the apparatus to:
calculate reputation scores for the respective users based on the highlights and/or annotations they made in the respective at least one electronic document;
wherein, the keywords presented to the user are configured so that, when one of the keywords is clicked or tapped by the user, the identifiers of all the users that have highlighted or annotated the keyword are presented, and
wherein, the identifiers of the users presented are configured so that, when one of the identifiers of the users is clicked or tapped, the reputation score of the user with the identifier is presented, together with links to the highlighted parts and/or annotations made by the user with the identifier.

17. The apparatus according to claim 10, wherein the at least one memory and the computer program code are further configured to, with the processor, cause the apparatus to:
create user profiles including the extracted keywords from highlighted parts and/or annotations in the at least one electronic document made by the respective users;
wherein to use the keywords as tags of the at least one electronic document to provide personalized contents from the at least one electronic document to a user comprises:
for at least one keyword in the user profile of the user, to calculate recommendation scores for the at least one electronic document based on the importance scores of the at least one keyword in the respective at least one electronic document;
to rank the at least one electronic document by their recommendation scores; and
to recommend a predetermined number of electronic documents in the at least one electronic document with the highest recommendation scores to the user.

18. The apparatus according to claim 17, wherein to calculate recommendation scores for the at least one electronic document based on the importance scores of the at least one keyword in the respective at least one electronic document comprises:
for a keyword in the user profile of the user, to calculate a recommendation score for an electronic document as the multiplication of the importance score of the keyword in the electronic document and the number of occurrences of the electronic document in the body of electronic documents divided by the number of occurrences of the keyword in the body of electronic documents.

19. A non-transitory computer program product comprising at least one computer-readable storage medium having computer-executable program code instructions stored therein, the computer-executable program code instructions comprising program code instructions for:
receiving highlights and/or annotations in at least one electronic document made by at least one user;
extracting keywords from the respective at least one electronic document with the highlights and/or annotations as tags of the respective at least one electronic document; and
using the keywords as tags of the respective at least one electronic document to provide personalized contents from the at least one electronic document to a user.

20. An user interface, comprising:
a user interface control presented, at a display, in association with an electronic document with highlights and/or annotations, wherein keywords extracted from the electronic document with highlights and/or annotations are recorded with their importance scores in association with the electronic document, the user interface control configured to enable a user to select a threshold, so that only the keywords in the electronic document with highlights and/or annotations having importance scores above the threshold are presented to the user.

21. The user interface according to 20, wherein, the keywords presented to the user are configured so that, when one of the keywords is clicked or tapped by the user, the identifiers of all the users that have highlighted or annotated the keyword are presented, and
wherein, the identifiers of the users presented are configured so that, when one of the identifiers of the users is clicked or tapped, the reputation score of the user with the identifier, calculated based on the highlights and/or annotations they made in the respective at least one electronic document, is presented, together with links to the highlighted parts and/or annotations made by the user with the identifier.

22. A method, comprising:
receiving highlights and/or annotations in at least one electronic document made by a user;
extracting keywords from the respective at least one electronic document with the highlights and/or annotations as tags of the respective at least one electronic document; and
creating a user profile including the extracted keywords from the highlighted parts and/or annotations in the at least one electronic document made by the user.
